(19) United States
(12) Patent Application Publication
(10) Pub. No.: US 2023/0046696 A1
(43) Pub. Date: Feb. 16, 2023

(54) METHOD AND SYSTEM FOR PROVISIONING REALTIME SOCIAL COMMUNITY BASED ON LOCATION SERVICE

(71) Applicant: Shusheng Fang, Upper Saddle River, NJ (US)

(72) Inventor: Shusheng Fang, Upper Saddle River, NJ (US)

(21) Appl. No.: 17/398,880

(22) Filed: Aug. 10, 2021

(51) Int. Cl. H04W 4/21; H04W 4/029; H04L 29/06; H04L 12/58; H04W 4/44; H04M 1/60; H04W 4/50

(52) U.S. Cl. CPC H04W 4/21; H04W 4/029; H04L 65/1069; H04L 51/046; H04L 51/32; H04W 4/44; H04M 1/6083; H04W 4/50; H04M 2201/40

(57) ABSTRACT

A computer implemented method for provisioning real-time social community based on location services, the computer implemented method includes: transmitting vehicle-related data to a database; receiving one or more vehicle-related preference corresponding to the vehicle-related data; filtering the vehicle-related data based on the vehicle-related preference to generate at least one filtered vehicle-related data corresponding to the other one of the end users; establishing a chat session between the one end user and the other one of the end users; and transmitting first associated data via the chat session.

### FIELD OF THE DISCLOSURE

The present disclosure relates to a method and system for provisioning real-time social community, and more particularly to the method and system for provisioning real-time social community based on location services associated with vehicle-related data stored on a database, which enable one user to communicate with certain users associated with the selected vehicles.

### BACKGROUND OF THE DISCLOSURE

Generally, a widely used location internet application is a location system that has been developed for determining and tracking the locations of the users of mobile devices, such as cellular phones, including a global positioning system (GPS). This existed application also may determine locations of devices based on movement in reference to a set of known coordinates. In addition, the user could the application to report accidents, police officers, weather conditions, road conditions, or traffic congestion.

However, the above mentioned existed location application fails to provide the users to communicate with one another, and in such a way, one driver may use a horn, a loudspeaker, or blinking lights in order to warn the other drivers in certain dangerous driving conditions. For example, while one driver discovers a vehicle with flat tires, the one driver may try to warn the driver associated with the flat tire vehicle by pressing the horn and blink the front lights. However, it is a hassle for the driver to realize what does the warnings mean. For another example, while the highway patrol discovers a speeding vehicle, they usually use flashing lights or loudspeakers for waring the driver to pull over, and in such a manner, the other driver may be interrupted by the series of actions.

In another non-limiting example, the highway patrol may use a helicopter to catch the speeding vehicles, and the highway patrol may also use the loudspeakers to warn the driver and let them pull over. However, these series of actions are extremely time-consuming and lack efficiency.

Therefore, there is a continuing need for new ways to enable the drivers to communicate with each other in order to keep a safe driving environment; to share information (transportation, SOS, restaurants, hotels, entertainment, etc.); and to establish social networks with other users.

All referenced patents, applications and literatures are incorporated herein by reference in their entirety. Furthermore, where a definition or use of a term in a reference, which is incorporated by reference herein, is inconsistent or contrary to the definition of that term provided herein, the definition of that term provided herein applies and the definition of that term in the reference does not apply. The disclosed embodiments may seek to satisfy one or more of the above-mentioned desires. Although the present embodiments may obviate one or more of the above-mentioned desires, it should be understood that someaspects of the embodiments might not necessarily obviate them.

### BRIEF SUMMARY OF THE DISCLOSURE

In a general implementation, a computer implemented method for provisioning real-time social community based on location services, the computer implemented method comprises transmitting, using a first communication device by one end user, vehicle-related data to a database; determining, using a processing server, a current location of the first communication device associated with the one end user; receiving, using the processing server, one or more vehicle-related preference corresponding to the vehicle-related data; filtering, using the processing server, the vehicle-related data based on the vehicle-related preference to generate at least one filtered vehicle-related data corresponding to the other one of the end users; establishing a chat session between the one end user and the other one of the end users; and transmitting, using the first communication device, first associated data via the chat session.

In another aspect combinable with the general implementation, the method further comprises displaying a first notification associated with the filtered vehicle-related data on the first communication device.

In another aspect combinable with the general implementation, the method further comprises transmitting, using the first communication device by the one end user, a request command to the second communication device associated with the other one of the end users.

In another aspect combinable with the general implementation, the vehicle-related preference includes one or more characteristics of a desired vehicle.

In another aspect combinable with the general implementation, the method further comprises capturing, using a microphone embedded in the first communication device by the one end user, vehicle-related preference.

In another aspect combinable with the general implementation, the method further comprises inputting, using an input interface associated with the first communication device by the one end user, vehicle-related preference.

In another aspect combinable with the general implementation, the method further comprises determining, using the processing server, a current location of the other one of the end users and/or the end user.

In another aspect combinable with the general implementation, in response to filtering that the vehicle-related data based on the vehicle-related preference, the method further comprises causing a second notification to be displayed on a second communication device of the other one of the end users.

In another aspect combinable with the general implementation, the method further comprises transmitting, using the second communication device, second associated data via the chat session by a second voice command.

In another aspect combinable with the general implementation, the first associated data is transmitted via the chat session by first voice commands or first text commands.

In another aspect combinable with the general implementation, the vehicle-related preference includes license plates of vehicles, colors of vehicles, manufacturers of vehicles, modules of vehicles, and identification information of the end users.

Another aspect of the embodiment is directed to a system comprising one or more communication devices; a processing server configured to cause the system to perform operations comprising: transmitting, using a first communication device by one end user, vehicle-related data to a database; determining, using the processing server, a current location of the first communication device by the one end user; receiving, using the processing server, one or more vehicle-related preference corresponding to the vehicle-related data; filtering, using the processing server, the vehicle-related data based on the vehicle-related preference to generate at least one filtered vehicle-related data associated with the other one of the end users; establishing a chat session between the one end user and the other one of the end users; and transmitting, using the first communication device, first associated data via the chat session.

In another aspect combinable with the general implementation, the operations further comprise transmitting, using the first communication device by the first user, a request command to the second user.

In another aspect combinable with the general implementation, in response to transmitting the request command, the operations further comprise causing a first notification to be displayed on the first communication device associated with the end user.

In another aspect combinable with the general implementation, the vehicle-related preference includes one or more characteristics of a desired vehicle.

In another aspect combinable with the general implementation, the operations further comprise capturing, using a microphone embedded in the first communication device by the one end user, vehicle-related preference.

In another aspect combinable with the general implementation, the operations further comprise inputting, using an input interface associated with the first communication device by the one end user, vehicle-related preference

In another aspect combinable with the general implementation, the operations further comprise determining a current location of the end user and/or the other one of the end users.

In another aspect combinable with the general implementation, the operations further comprise in response to filtering that the vehicle-related data based on the vehicle-related preference, causing a second notification to be displayed on a second communication device of the other one of the end users.

In another aspect combinable with the general implementation, the operations further comprise transmitting, using the second communication device, second associated data via the chat session.

While this specification contains many specific implementation details, these should not be construed as limitations on the scope of any inventions or of what may be claimed, but rather as descriptions of features specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above and below as acting in certain combinations and even initially claimed as such, one or more features from a claimed combination can in some cases be excised from the combination, and the claimed combination may be directed to a subcombination or variation of a subcombination.

A number of implementations have been described. Nevertheless, it will be understood that various modifications may be made without departing from the spirit and scope of the disclosure. For example, example operations, methods, or processes described herein may include more steps or fewer steps than those described. Further, the steps in such example operations, methods, or processes may be performed in different successions than that described or illustrated in the figures. Accordingly, other implementations are within the scope of the following claims.

The details of one or more implementations of the subject matter described in this disclosure are set forth in the accompanying drawings and the description below. Other features, aspects, and advantages of the subject matter will become apparent from the description, the drawings, and the claims.

### BRIEF DESCRIPTION OF THE DRAWINGS

It should be noted that the drawing figures may be in simplified form and might not be to precise scale. In reference to the disclosure herein, for purposes of convenience and clarity only, directional terms such as top, bottom, left, right, up, down, over, above, below, beneath, rear, front, distal, and proximal are used with respect to the accompanying drawings. Such directional terms should not be construed to limit the scope of the embodiment in any manner.

FIGS. 1A-1B are block diagrams of a method and system for provisioning real-time social community based on location services according to an embodiment.

FIG. 2 is a block diagram of a method for provisioning real-time social community based on location services according to the embodiment.

FIG. 3 is a block diagram of the method for provisioning real-time social community based on location services according to the embodiment

FIG. 4 is a block diagram of the method for provisioning real-time social community based on location services according to the embodiment

FIG. 5 presents a user interface that may be presented on a communication device and provides the location of the end users.

FIG. 6 presents the user interface that may be presented on the communication device and provide the step of inputting vehicle-related preferences through a voice command (audio data).

FIG. 7 presents the user interface that may be presented on the communication device and provides the step of filtering the vehicle-related data stored into the database based on the vehicle-related preference.

FIG. 8 presents the user interface that may be presented on the communication device and provides the step of displaying the filtered vehicle-related data on the first communication device.

FIG. 9 presents the user interface that may be presented on the communication device and provides the step of selecting one of the filtered vehicle-related data

FIG. 10 presents the user interface that may be presented on the communication device and provides the step of transmitting the request command (the friend request) to a selected filtered vehicle-related data associated with the second user.

FIG. 11 presents the user interface that may be presented on the communication device and provides the step of establishing a chat session between the one end user (the first user) and the other one of the end user (the second user).

FIG. 12 presents the user interface that may be presented on the communication device and provides the step of inputting the first text/audio commands on the chat session.

### DETAILED DESCRIPTION OF THE EMBODIMENTS

The different aspects of the various embodiments can now be better understood by turning to the following detailed description of the embodiments, which are presented as illustrated examples of the embodiments defined in the claims. It is expressly understood that the embodiments as defined by the claims may be broader than the illustrated embodiments described below.

The term “a” or “an” entity refers to one or more of that entity. As such, the terms “a” (or “an”), “one or more” and “at least one” can be used interchangeably herein. It is also to be noted that the terms “comprising,” “including,” and “having” can be used interchangeably.

It shall be understood that the term “means,” as used herein, shall be given its broadest possible interpretation in accordance with 35 U.S.C., Section 112(f). Accordingly, a claim incorporating the term “means” shall cover all structures, materials, or acts set forth herein, and all of the equivalents thereof. Further, the structures, materials or acts and the equivalents thereof shall include all those described in the summary of the invention, brief description of the drawings, detailed description, abstract, and claims themselves.

Unless defined otherwise, all technical and position terms used herein have the same meaning as commonly understood by one of ordinary skill in the art to which the invention pertains. Although many methods and materials similar, modified, or equivalent to those described herein can be used in the practice of the present invention without undue experimentation, the preferred materials and methods are described herein. In describing and claiming the present invention, the following terminology will be used in accordance with the definitions set out below.

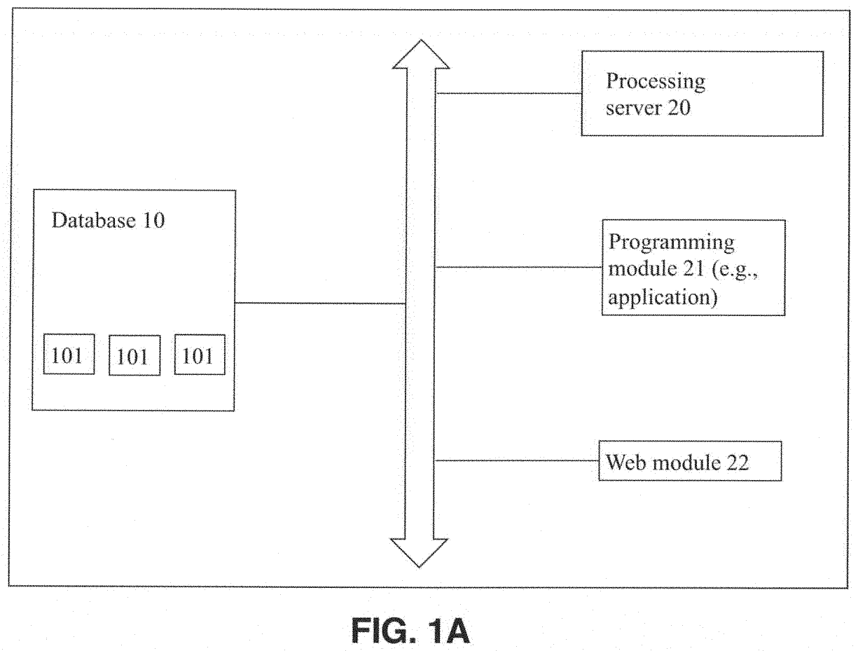

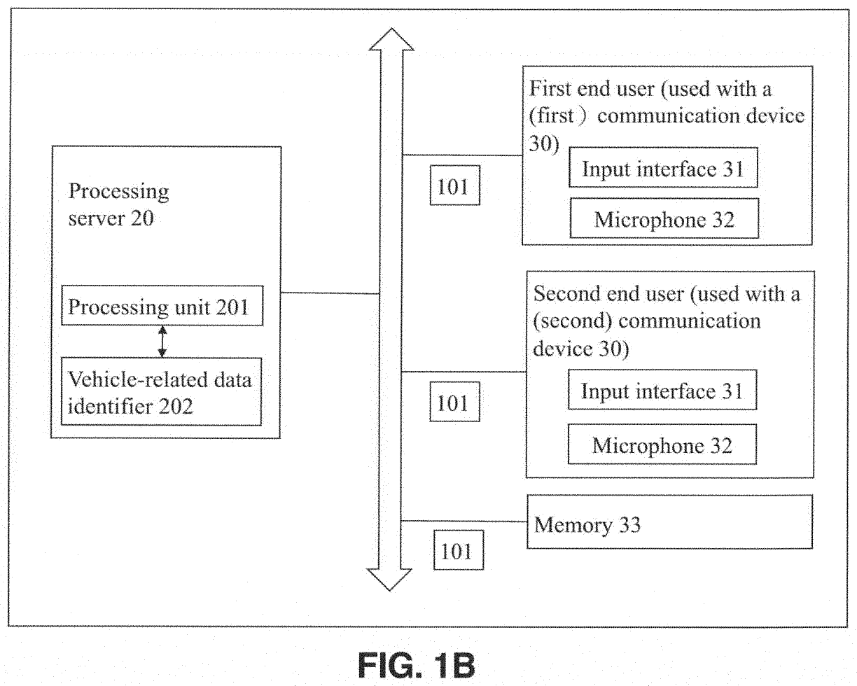

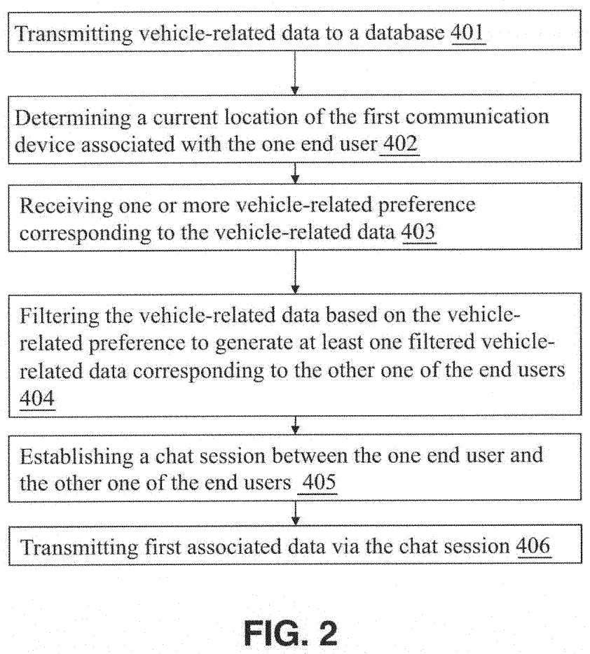

Referring to FIGS. 1A-1B and FIG. 2, the present invention comprises a real-time social community system that may provide location services associated with vehicle-related data associated with more than one communication devices 30. The real-time social community system may comprise a database 10 containing vehicle-related data 101, a processing server 20, and more than one communication devices 30 which runs the processing server 20.

In some embodiments, the processing server 20 may be a programming module 21 and/or a web module 22, wherein the processing server 20 may communicate with the communication devices 30 and the database 10. It should be noted that the programming module 21 may be an application which may be run by the communication devices 30, and the web module 22 may be a browser which may be also run by the communication devices 30.

In some embodiments, the processing server 20 (the processing module or/and the web module 22) may comprise a processing unit 201 and a vehicle-related data identifier 202, wherein the processing server 20 may be operated by the communication devices 30, including a first communication device and a second communication device.

In some embodiments, the real-time social community system may comprise the database 10 which may communicate with the more than one communication devices 30 through the processing server 20. The vehicle-related data 101 may be stored in the database 10. In particular, the vehicle-related data 101 may be representative of license plates of vehicles, colors of vehicles, manufacturers of vehicles, modules of vehicles, and identification information associated with end users.

In some embodiments, the real-time social community system may further comprise a memory 33 which may operatively communicate with the communication device 30. The memory 33 may be embedded inside the communication device 30 to store vehicle-related data 101. For another example, the memory 33 may be a cloud storage for allowing the vehicle-related data 101 being stored therein.

In some embodiments, the end users may input the vehicle-related data 101 via the communication devices 30 to the processing server 20. The vehicle-related data 101 may be received by the processing unit 201 of the processing server 20 and transmitted to the database 10. It should be noted that the vehicle-related data 101 may be stored into the database 10.

In some embodiments, the vehicle-related data 101 may flow from the database 10 to the processing server 20. It should be noted that the vehicle-related data 101 may flow between the database 10 and the communication devices 30 via the processing server 20. Accordingly, the vehicle-related data 101 may be generated from the communication devices 30 associated with the end users via an input interface 31 or a microphone 32, wherein the input interface 31 may be a keyboard, a touch screen, or a mouse which enables the end user to generate input signals, and the input signals may be transformed to vehicle-related data 101 (by a CPU embedded inside the communication device 30) and then flow to the processing server 20 which may be run by the communication devices 30.

Accordingly, the input interface 31 may be used to generate text commands which may be transformed to text data by the CPU inside the communication devices 30. In some embodiments, the text data may be associated data which may be used to communicate between more than one end users. For example, the one end user (a first user) may generate first text commands through the input interface 31 embedded inside a first communication device 30, wherein the first text commands may be transformed to first text data (first associated data), and then be transmitted to the processing server 20 which enables the other one of the end users (a second user) to obtain the first associated data. In response to that the first associated data obtained by the other one of the end users (the second user), the other one of the end users (the second user) may generate second text commands through the input interface 31 embedded inside a second communication device 30, wherein the second text commands may be transformed to second text data (second associated data). The second text data (second associated data) may be transmitted to the processing server 20 which enables the one end user (the first user) to obtain the second text data (second associated data).

In some embodiments, the microphone 32 may be embedded inside the communication devices 30 to generate voice commands, wherein the voice commands may be transformed to audio data by the CPU inside the communication devices 30. In some embodiments, the audio data may be associated data which may be used to communicate between more than one end users. For example, one end user (the first user) may capture first voice commands through the microphones 32 embedded inside the first communication device 30 or generate first text commands through the input interface 31 embedded inside the first communication device 30, wherein the first voice commands or the first text commands may be transformed to the first audio data (first associated data), and the first audio data (first associated data) may be transmitted to the processing server 20 which enables the other one of the end users (a second user) to obtain the first associated data. In response to that the first associated data may be obtained by the other one of the end users (the second user), the other one of the end users (the second user) may capture second voice commands through the microphones 32 embedded inside the second communication device 30 or generate the second text commands through the input interface 31 embedded inside the second communication device 30, wherein the second voice commands or the second text commands may be transformed to second audio data (second associated data), wherein the second audio data (second associated data) may be transmitted to the processing server 20 which enables the one end user (the first user) to obtain the second audio data (second associated data).

In some embodiments, the communication devices 30 may be various types of devices, including, but not limited to, a personal computer, a desktop computer, a laptop, notebook, a mobile device, a video game console, or in general types of computing or electronic devices. It should be noted that the end users may include, but are not limited to, general public users or personnel, such as police officers, firemen, or ambulance officers, to communicate with the general public users.

In some embodiments, the processing server 20 (the programming module 21 or/and the web module 22), may provide a geographic application which determines the current location of one or more communication devices 30 associated with the corresponding end users.

In some embodiments, the one end user (the first user) may, using the first communication device, input vehicle-related preferences into the processing unit 201 of the processing server 20, wherein the vehicle-related preference may be corresponding to license plates of vehicles, colors of vehicles, manufacturers of vehicles, and modules of vehicles, which are associated with the end users. The processing unit 201 of the processing server 20 may transform the vehicle-related preferences to the vehicle-related data and transmit the vehicle-related data to the vehicle-related data identifier 202.

In such a manner, the vehicle-related data identifier 202 of the processing server 20 (the programming module 21 or/and the web module 22) may provide operations to filter the vehicle-related data based on the vehicle-related preference to generate at least one filtered vehicle-related data corresponding to the other one of the end users (the second end user).

In some embodiments, the vehicle-related data identifier 202 of the processing server 20 may display the at least one filtered vehicle-related data representative of a first notification to be displayed on the first communication device associated with the first user. It should be noted that the filtered vehicle-related data may include identification information associated with the end users.

In some embodiments, the processing unit 201 of the processing server 20 (the programming module 21 or/and the web module 22) operated by the first communication device 30 associated with the first user may provide operations to transmit a request command to the second communication device 30 associated with the second user. For example, the request command may be a friend request which enables the second user to either accept or reject the friend request. For another example, while the second user accepts the friend request, the first user may transmit the first associated data, using the processing unit 201 of the processing server 20, to the second user. For another example, while the second user, using the processing unit 201, rejects the friend request, the first user may not allow transmitting the first associated data to the second user via the processing unit 201 of the processing server 20.

Accordingly, in some embodiments, the one end user (the first user) may, using the processing unit 201 of the processing server 20, select one of the identification information (one of the filtered vehicle-related data) associated with the other one of the end users (the second user) and transmit, using the processing unit 201 of the processing server 20, the request command (the friend request) to the second communication device associated with the selected identification information (selected filtered vehicle-related data) associated with the other one of the end user (the second user).

In some embodiments, the processing unit 201 of the processing server 20 (the programming module 21 or/and the web module 22) may provide operations, in response to that transmitting the request command to the other one of the end user (the second user), of causing a second notification to be displayed on the second communication device 30 of the other one of the end users (the second user).

In some embodiments, while the other one of the end user (the second user), using the processing unit 201 of the processing server 20, accepts the request command (the friend request represented as the second notification to be displayed on the second communication device 30), the processing unit 201 of the processing server 20 (the programming module 21 or/and the web module 22) may provide operations to establish a chat session between the one end user (the first user) and the other one of the end users (the second user). In a known manner, the one end user (the first user) may, using the processing unit 201 of the processing server 20, transmit the first audio data and/or the first text data to be displayed on the chat session to the other one of the end users (the second user), and in response to receive, using the processing unit 201 of the processing server 20, the first audio data and/or the first text data, the other one of the end users (the second user) may transmit, using the processing unit 201 of the processing server 20, the second audio data and/or the second text data to be displayed on the chat session in order to communicate with the one end user (the first user).

Continuing to FIG. 2, FIG. 2 is a flowchart of a computer implemented method for provisioning real-time social community based on location services. The end user (the first user) may transmit vehicle-related data through the processing unit of the processing server operated by the first communication device to the database (block 401), wherein the vehicle-related data may be stored into the database. The first communication device may run the processing server (the programming module and/or the web module), and the processing unit of the processing server may determine a current location of the first communication device associated with the one end user (the first user) (block 402). The end user (the first user) may use the processing unit of the processing server to send one or more vehicle-related preference. In other words, the processing unit of the processing server may receive one or more vehicle-related preference (block 403). The one or more vehicle-related preference may be corresponding to the vehicle-related data, which include, but not limited to, license plates of vehicles, colors of vehicles, manufacturers of vehicles, modules of vehicles, and identification information of the end users.

In some embodiments, the vehicle-related data identifier of the processing server may filter the vehicle-related data stored into the database to generate at least one filtered vehicle-related data corresponding to the other one of the end users (the second user) (block 404). The processing unit of the processing unit may establish a chat session between the one end user (the first user) and the other one of the end user (the second user) (block 405), and in such a manner, the one end user (the first user) may transmit, using the processing unit of the processing server, the first associated data to the chat session via the first communication device (block 406).

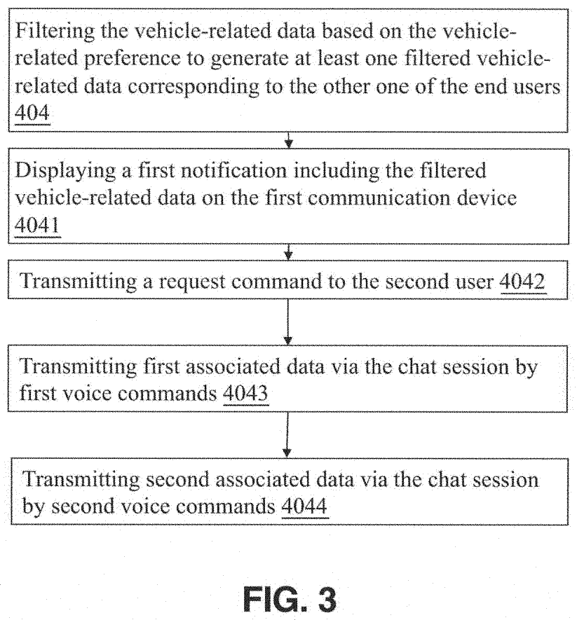

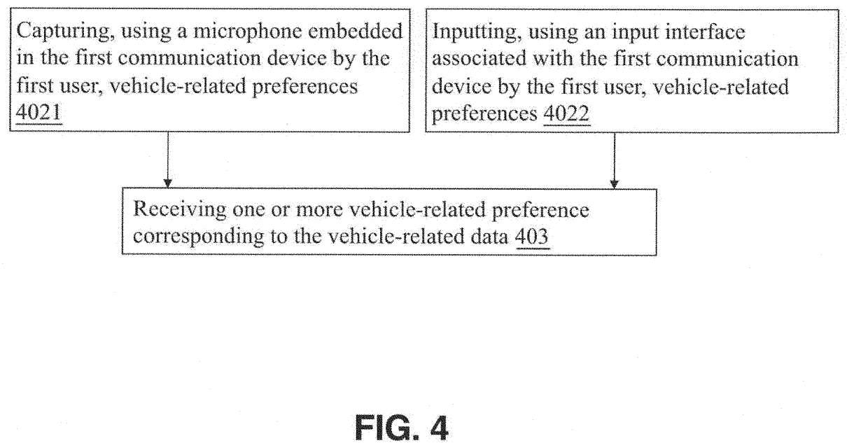

FIGS. 3-4 generally depict the computer implemented method for provisioning real-time social community based on location services.

Referring to FIGS. 3-4, the vehicle related data identifier may display the filtered vehicle-related data on the first communication device and the filtered vehicle-related data may be representative of a first notification (block 4041). The vehicle-related data identifier may transmit the filtered vehicle-related data to the processing unit. The one end user (the first user) may, using the processing unit of the processing server, select one of the filtered vehicle-related data and may transmit a request command (a friend request) to at least one selected filtered vehicle-related data associated with the other one of the end users (the second user) (block 4042).

Accordingly, in response to transmitting that the request command, the processing unit of the processing server may cause a second notification to be displayed on the second communication device of the other one of the end users (the second user).

In some embodiments, in response to displaying that the second notification on the second communication device associated with the other one of the end users (the second user), the other one of the end users (the second user) may use the processing unit of the processing server to selectively accept or reject the request command sent from the one end user (the first user).

In some embodiments, while the other one of the end users (the second user) may use the processing unit of the processing server to accept the request command (the friend request), the one end user (the first user) may use the processing unit of the processing server to transmit the first associated data to the other one of the end users (the second user). The processing unit may display the first associated data via the chat session (block 4043). In response to transmitting that the first associated data, the other one of the end users (the second user) may transmit, using the processing unit of the processing server, the second associated data to be displayed on the chat session (block 4044).

In some embodiments, the processing unit of the processing server may transform first voice/text commands to the first associated data and the second associated data, wherein the first voice/text commands and the second voice/text commands may be inputted by the one end user (the first user) and the other one of the end users (the second user) through the processing unit of the processing server operated by the first and second communication devices.

In some embodiments, as shown in FIG. 4, the vehicle-related preference may be generated by the one end user (the first user) via, but not limited to, capturing, using the microphone embedded in the first communication device by the one end user (the first user) (block 4021), vehicle-related preferences, or inputting, using the input interface associated with the first communication device by the one end user (the first user), vehicle-related preferences (block 4022).

In some embodiments, the processing unit of the processing server may provide the operations of determining a current location of the other one of the end users and/or the one end user (block 402) (see details in FIG. 2).

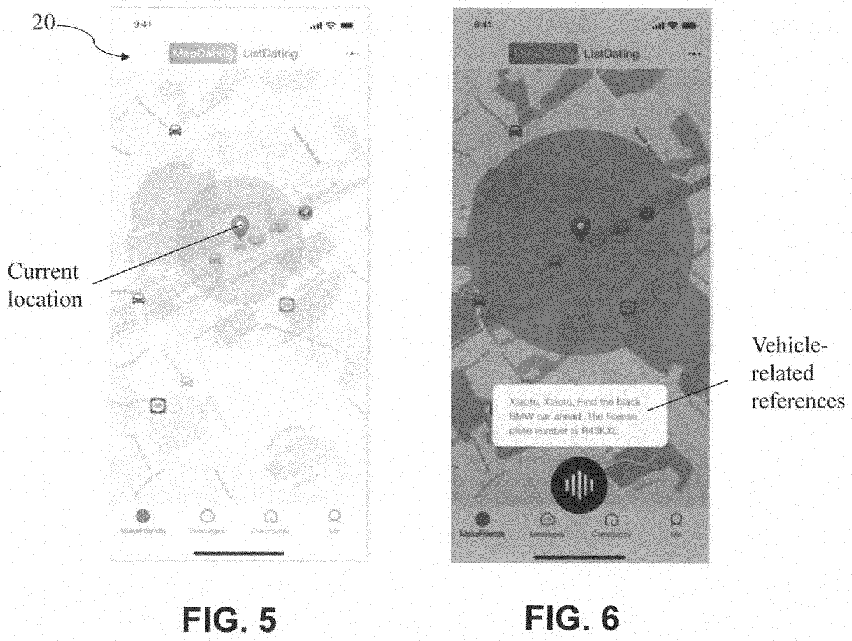

FIG. 5 to FIG. 12 generally depicts an example showing how the method and system for provisioning the real-time social community based on the location services according to the present invention.

Referring to FIGS. 5-6, the processing server 20 may provide the operations of determining the current location of the one end user (the first user), and then the one end user (the first user) may input vehicle-related preferences to the first communication device through a voice form (audio data).

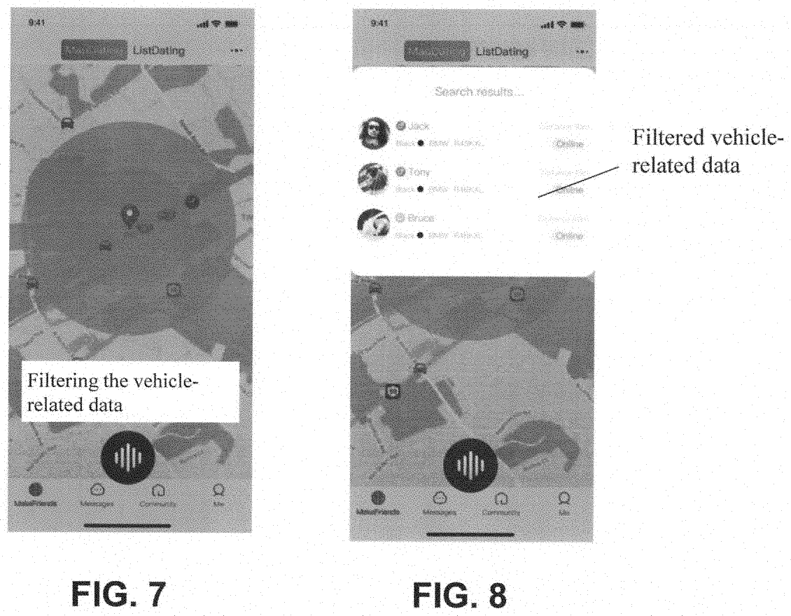

Referring to FIGS. 7-8, the processing server may filter the vehicle-related data stored into the database based on the vehicle-related preferences, and the filtered vehicle-related data may be displayed on the first communication device via the first notification.

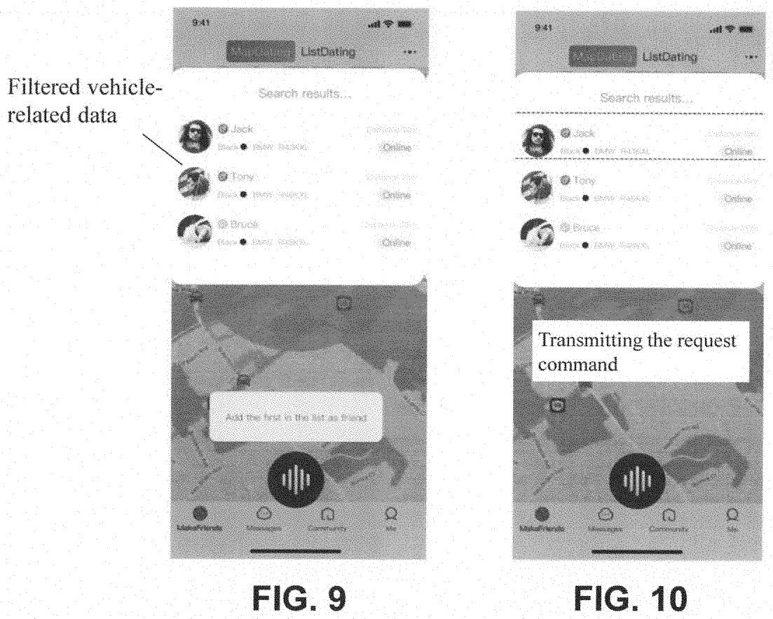

Referring to FIGS. 9-10, the one end user (the first user) may select one of the filtered vehicle-related data and then the processing server may transmit the request command (the friend request) to the selected filtered vehicle-related data associated with the second user.

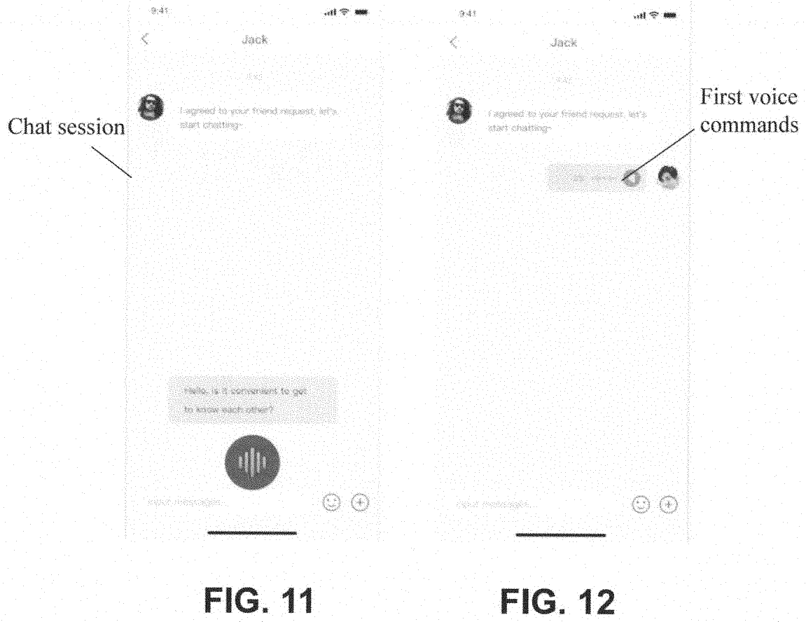

Referring to FIGS. 11-12, after the other one of the end users (the second user) accepts the request command (the friend request), the chat session may be established between the one end user (the first user) and the other one of the end user (the second user). The one end user (the first user) may input the first text/voice commands on the chat session. In the other hands, the other one of the end users (the second user) may input the second text/voice commands on the chat session in order to communicate with the one end user (the first user).

Similarly, while operations and/or methods may be depicted in the drawings in a particular order, this should not be understood as requiring that such operations be performed in the particular order shown or in sequential order, or that all illustrated operations and/or method steps be performed, to achieve desirable results. In certain circumstances, multitasking and parallel processing may be advantageous.

Many alterations and modifications may be made by those having ordinary skill in the art without departing from the spirit and scope of the disclosed embodiments. Therefore, it must be understood that the illustrated embodiments have been set forth only for the purposes of example and that it should not be taken as limiting the embodiments as defined by the following claims. For example, notwithstanding the fact that the elements of a claim are set forth below in a certain combination, it must be expressly understood that the embodiment includes other combinations of fewer, more, or different elements, which are disclosed herein even when not initially claimed in such combinations.

Thus, specific embodiments and applications of method and system for provisioning real-time social community based on the location services have been disclosed. It should be apparent, however, to those skilled in the art that many more modifications besides those already described are possible without departing from the disclosed concepts herein. The disclosed embodiments, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Insubstantial changes from the claimed subject matter as viewed by a person with ordinary skill in the art, now known or later devised, are expressly contemplated as being equivalent within the scope of the claims. Therefore, obvious substitutions now or later known to one with ordinary skill in the art are defined to be within the scope of the defined elements. The claims are thus to be understood to include what is specifically illustrated and described above, what is conceptually equivalent, what can be obviously substituted and also what essentially incorporates the essential idea of the embodiments. In addition, where the specification and claims refer to at least one of something selected from the group consisting of A, B, C . . . and N, the text should be interpreted as requiring at least one element from the group which includes N, not A plus N, or B plus N, etc.

The words used in this specification to describe the various embodiments are to be understood not only in the sense of their commonly defined meanings, but to include by special definition in this specification structure, material or acts beyond the scope of the commonly defined meanings. Thus if an element can be understood in the context of this specification as including more than one meaning, then its use in a claim must be understood as being generic to all possible meanings supported by the specification and by the word itself.

The definitions of the words or elements of the following claims therefore include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a subcombination or variation of a subcombination.

What is claimed is:

1. A computer implemented method for provisioning real-time social community based on location services, the computer implemented method comprising:
transmitting vehicle-related data to a database;
receiving one or more vehicle-related preference corresponding to the vehicle-related data;
filtering the vehicle-related data based on the vehicle-related preference to generate at least one filtered vehicle-related data corresponding to the other one of the end users;
establishing a chat session between the one end user and the other one of the end users; and
transmitting first associated data via the chat session.

2. The computer implemented method of claim 1, further comprising displaying a first notification associated with the filtered vehicle-related data.

3. The computer implemented method of claim 2, further comprising transmitting a request command to a second communication device associated with the other one of the end users.

4. The computer implemented method of claim 1, wherein the vehicle-related preference includes one or more characteristics of a desired vehicle.

5. The computer implemented method of claim 1, further comprising capturing, using a microphone embedded in a first communication device by the one end user, vehicle-related preferences.

6. The computer implemented method of claim 1, further comprising inputting, using an input interface associated with a first communication device by the one end user, vehicle-related preferences

7. The computer implemented method of claim 1, further comprising determining a current location of the other one of the end users and/or the one end user.

8. The computer implemented method of claim 1, wherein in response to filtering that the vehicle-related data based on the vehicle-related preferences, further comprising causing a first notification associated with the filtered vehicle-related data to be displayed on a first communication device of the one end user.

9. The computer implemented method of claim 1, further comprising transmitting second associated data via the chat session by a second voice command.

10. The computer implemented method of claim 1, wherein the first associated data is transmitted via the chat session by first voice commands or a first text commands.

11. The computer implemented method of claim 1, wherein the vehicle-related preferences include license plates of vehicles, colors of vehicles, manufacturers of vehicles, modules of vehicles, or identification information of the end users.

12. A real-time social community system comprising: one or more communication devices including a first communication device and a second communication device;
a processing server comprising a processing unit and a vehicle-related data identifier; wherein
the processing server is configured to cause the system to perform operations comprising:
transmitting, using the processing unit, vehicle-related data to a database;
receiving, using the processing unit, one or more vehicle-related preference corresponding to the vehicle-related data;
filtering, using the vehicle-related data identifier, the vehicle-related data based on the vehicle-related preference to generate at least one filtered vehicle-related data associated with the other one of the end users;
establishing, using the processing unit, a chat session between the one end user and the other one of the end users; and
transmitting, using the processing unit, first associated data via the chat session to the other one of the end users.

13. The system of claim 12, where the operations further comprise transmitting, using the processing unit operated by the first communication device by the first user, a request command to the second user.

14. The system of claim 13, in response to transmitting the request command, the operations further comprise causing a second notification, using the processing unit, to be displayed on a second communication device associated with the other one of the end users.

15. The system of claim 12, wherein the vehicle-related preference includes one or more characteristics of a desired vehicle.

16. The system of claim 12, wherein the operations further comprise capturing, using a microphone embedded in the first communication device by the one end user, vehicle-related preferences.

17. The system of claim 12, wherein the operations further comprise inputting, using an input interface associated with the first communication device by the one end user, vehicle-related preferences.

18. The system of claim 12, wherein the operations further comprise determining, using the processing unit, a current location of the one end user and/or the other one of the end users.

19. The system of claim 12, wherein in response to filtering that the vehicle-related data based on the vehicle-related preference, the operations further comprise causing, using the processing unit, a first notification to be displayed on the first communication device of the one end user.

20. The system of claim 12, wherein the operations further comprise transmitting, using the processing unit operated by the second communication device, second associated data via the chat session.
